(19) United States
(12) Patent Application Publication
(10) Pub. No.: US 2003/0025316 A1
(43) Pub. Date: Feb. 6, 2003

(54) Ultraviolet writing system

(75) Inventors: Iris Solomon, Van Nuys, CA (US); Ronald Solomon, Van Nuys, CA (US)

Correspondence Address: CURTIS MALLET-PREVOST COLT & MOSLE,LLP, 101 PARK AVENUE, 35TH FLOOR, NEW YORK, NY, 10178, US

(73) Assignee: Swingset Press LLC, Van Nuys, CA (US)

(21) Appl. No.: 09/904,737

(22) Filed: Jul. 13, 2001

Related U.S. Application Data
(60) Provisional application No. 60/218,197, filed on Jul. 14, 2000.

(51) Int. Cl. B42D 1/00; B42D 5/00

(52) U.S. Cl. 281/15.1

(57) ABSTRACT

A writing system utilizing ultraviolet light and ultraviolet sensitive ink, preferably used with a diary or journal. The ultraviolet sensitive ink is preferably colorless under normal lighting and under such normal lighting does not appear on the paper used with the writing system, which paper is preferably white or black. When written upon, the paper will appear to be blank under normal lighting. Once the ultraviolet light is activated over the surface of the pages, illuminating the ultraviolet sensitive ink, text or drawings created with the ultraviolet ink will be revealed.

### FIELD OF THE INVENTION

The invention relates to all forms of writing and drawing with the intention of guarding the handwritten and/or drawn content through a combination of special ink, paper and light. The present invention is of particular relevance to products such as personal diaries, journals, stationery and games.

### BACKGROUND OF THE INVENTION

Diaries and journals have incorporated security measures to make their content more secure and prevent or limit unwanted access. Many diaries and journals employ locking devices ranging in type from simple padlocks and manual combination locks to digital combination locks and voice activated locking systems. One problem with locking devices is that the very existence of the locking device may invite unwanted intrusion. Further, to keep costs down for personal diaries or journals such as are typically purchased by children, the locks may not be very resistant to forced access.

The present invention advances the security of written, drawn or printed content by allowing said content to be visible only under ultraviolet light. In the absence of an appropriate ultraviolet light source, the written, drawn or printed content is indiscernible, allowing the content to remain private.

Ultraviolet light, also known as “black light,” has been used in novelty items such as posters and room decorations. Such novelty items have utilized the combination of an ultraviolet light source and ultraviolet reflective colorings, usually sold individually, to allow users to decorate rooms and other public places.

Ultraviolet light has been used for security purposes in amusement parks and nightclubs, where an ultraviolet sensitive ink is used as a handstamp, which handstamp is visible under ultraviolet light and allows the amusement parks and nightclubs to determine whether a person has previously been allowed entrance or otherwise identify patrons entering or leaving. Ultraviolet light has also been used in financial institutions for determining whether particular currency is counterfeit or real.

The present invention helps give consumers privacy in many retail product areas and may also be used in law enforcement applications.

It is an object of the present invention to provide the user with a new and private writing system.

### SUMMARY OF INVENTION

The present invention is a writing system which combines an ultraviolet light, ultraviolet sensitive ink and a writing surface, preferably a diary or journal. The ultraviolet sensitive ink is preferably colorless under normal lighting circumstances, so that when written upon, the writing surface will appear to be blank under normal lighting. Once the ultraviolet light is activated over the surface of the writing surface, text or drawings created with the ultraviolet ink will be revealed.

### BRIEF DESCRIPTION OF THE DRAWINGS

FIG. 1 is a front elevation view of the hand held battery operated, ultraviolet lamp.

FIG. 2 is a front elevation view of the pen with cap removed.

FIG. 3 is a front elevation view of two pages within a book, showing writing and drawings on a page being exposed to ultraviolet light and being visible.

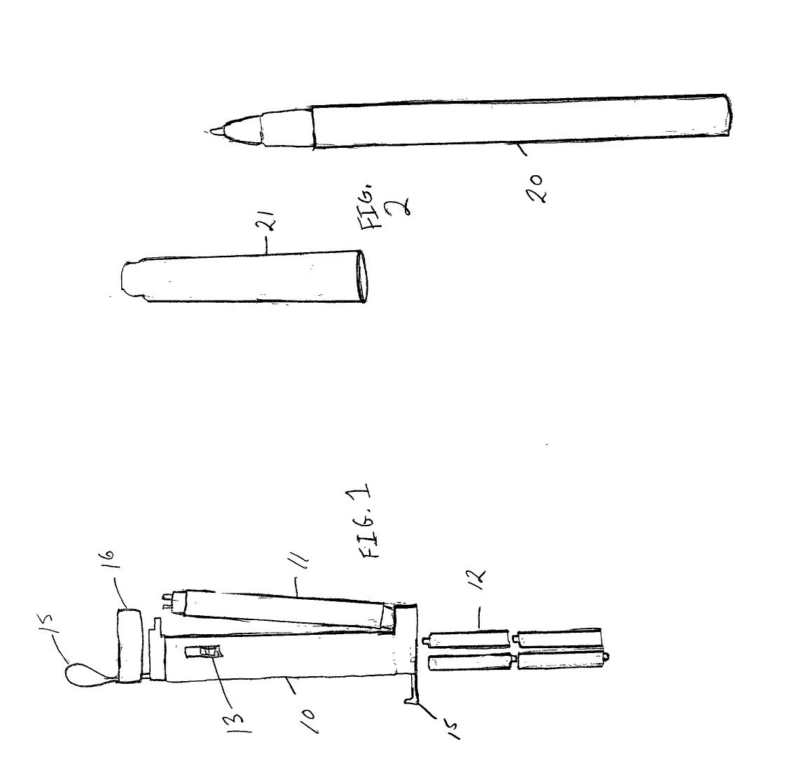

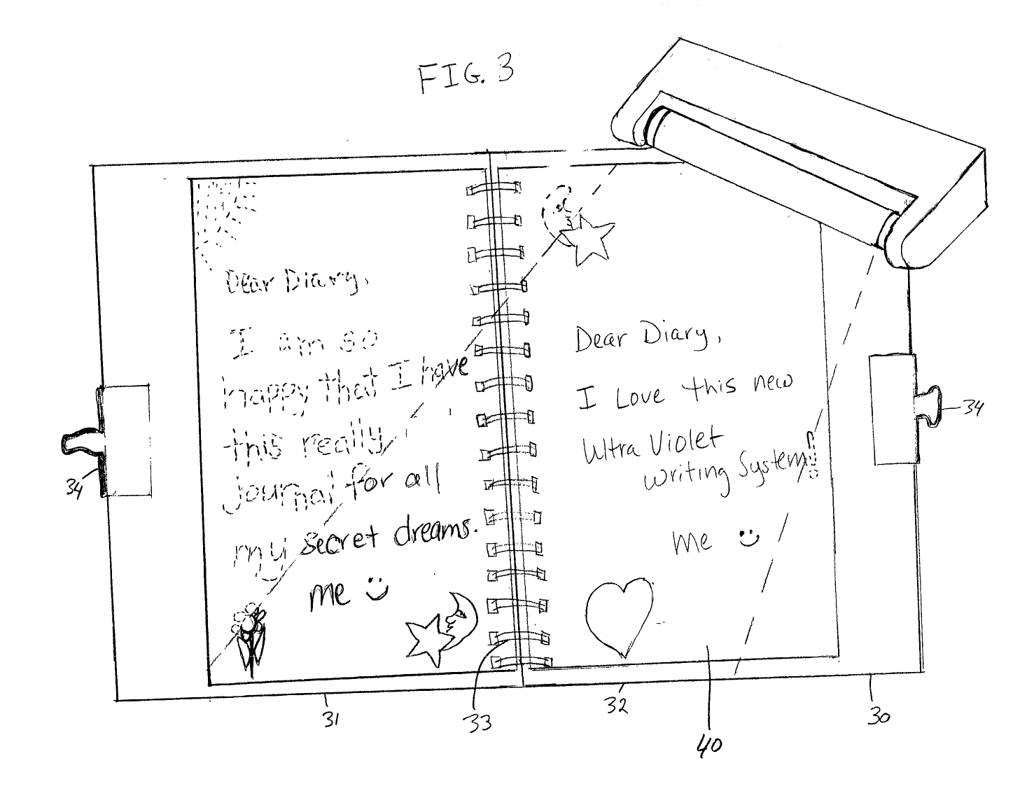

### DETAILED DESCRIPTION OF THE PREFERRED EMBODIMENTS

In its preferred embodiment, the present invention is composed of an ultraviolet light bulb 11, a lamp or light fixture 10 for the ultraviolet light bulb 11, a pen 20 containing ultraviolet ink 25 and a bound book 30 containing blank paper 40.

The ultraviolet light bulb 11 is fixed in a portable lamp 10, preferably powered by batteries 12. The portable lamp 10 is preferably lightweight, capable of being held easily by a child, although the lamp 10 may also include a stand to allow the ultraviolet light to shine in a desired direction. A commonly sold lamp as may be used with the invention includes a handstrap 14 and a battery compartment within the lamp which is covered by battery cover 15, and retains the ultraviolet light bulb 11 with bulb cover 16.

In the preferred embodiment, the ultraviolet light bulb 11 is cylindrical, where the light is emitted in a direction away from the axis of the cylindrical light bulb 11, allowing for a broad angle of emitted ultraviolet light of uniform intensity, for ease of use in both writing and reading. Such light bulbs are commonly sold as mercury vapor discharge bulbs.

The ultraviolet light emitted by the ultraviolet light bulb 11 is preferably of the range known as UV-A light, with wavelengths between 3500 and 3800 angstroms. UV-A is preferred as this type of ultraviolet light is considered to be harmless to human skin and eyes.

The ultraviolet ink 25 is preferably capable of emitting visible light in the center of the visible spectrum, between 5000 and 6000 angstroms. The ultraviolet ink 25 may emit the visible light either by reflection or by fluorescence upon illumination by the ultraviolet light. When the ink is exposed to visible light, including sunlight, incandescent or common fluorescent lighting sources, the reflection of such light is preferably the same as or close to the reflection from the paper upon which the ink is applied, thereby rendering the writing or drawing invisible in ordinary visible light. In the preferred embodiment, the ink 25 is based on a polyhydric alcohol solution with dyes introduced to provide the ultraviolet light reflection properties. Due to the anticipated use by children, the ink 25 is preferably non-toxic and compliant with various standards for other writing products.

Where the ink 25 contains fluorescent particles which are excited by ultraviolet light, the excited states of the fluorescent particles creates a light which is in the spectrum visible to the human eye. In the preferred embodiment, the excited state terminates upon the cessation of exposure to the ultraviolet light, or within a short period thereafter, so that the ink has no afterglow or phosphorescent effect.

As is known in the art, the ink is stored and dispensed in a conventional pen 20, such as felt-tipped or ball point pens. A cap 21 prevents the ink in the pen 20 from prematurely drying out.

The paper 40 is preferably manufactured without any coating. Due to the nature of ultraviolet ink available at the time of the creation of the present invention, white and black paper appears to be the preferred writing surface, presenting the greatest contrast between the paper and the ultraviolet light-illuminated ink. As the technology of ultraviolet ink improves, additional colored papers may also be used within the scope of the present invention.

For the journal or diary book 30 described in the drawings, the paper 40 may be bound in a book with front and back covers 31 and 32, as is known in the art. To complete the appearance of a private diary, a lock 34 may be incorporated into the front and back covers.

The writing system of the present invention is also applicable to use in stationery. Correspondence may be written using the ultraviolet ink and the recipient would only be able to read the correspondence through the use of an ultraviolet light.

The writing system of the present invention may also be used in games. Certain games require the use of a pad and writing instrument by a player to keep track of the player's progress. It is often desired for the player's writing to be kept confidential from other players. By writing with ultraviolet ink, a player may keep other players from easily seeing such progress notes, allowing for ease of game play.

While certain novel features of the present invention have been shown and described, it will be understood that various omissions, substitutions and changes in the forms and details of the device illustrated and in its operation can be made by those skilled in the art without departing from the spirit of the invention.

What is claimed is:

1. A writing system comprised of:
a lamp;
an ultraviolet light source mounted in the lamp;
means for connecting the lamp to an external power supply;
ink sensitive to ultraviolet light, where upon exposure to ultraviolet light, the ink emits light in a spectrum visible to human eyes, the appearance of the ink in the absence of ultraviolet light being nearly colorless;
a pen with a reservoir capable of retaining and dispersing the ink in a controlled manner;
paper;
a binder, with a front cover, a back cover and a spine, the binder capable of retaining the paper; and
locking means attached to the front cover and the back cover of the binder, the locking means capable of restricting access to the binder and the paper retained therein.

2. The writing system of claim 1,
where the wavelength of the ultraviolet light radiated from the ultraviolet light source is in the range of 3500 to 3800 angstroms and
where the wavelength of the visible light emitted by the ultraviolet ink upon exposure to ultraviolet light is in the range of 3900 to 7700 angstroms.

3. A writing system comprised of:
a lamp;
means for connecting the lamp to an external power supply;
an ultraviolet light source mounted in the lamp, the ultraviolet light source being capable of radiating ultraviolet light;
ink sensitive to ultraviolet light, where upon exposure to ultraviolet light the ink reflects light in a spectrum visible to human eyes, the appearance of the ink in the absence of ultraviolet light being nearly colorless;
a pen with a internal reservoir capable of retaining and dispersing the ink in a controlled manner; and
a writing surface.

4. The writing system of claim 3,
where the wavelength of the ultraviolet light radiated from the ultraviolet light source is in the range of 3500 to 3800 angstroms and
where the wavelength of the visible light reflected by the ink upon exposure to ultraviolet light is in the range of 3900 to 7700 angstroms.

5. A journal writing kit comprised of
a handheld lamp;
means for connecting the handheld lamp to an external power supply;
an ultraviolet light bulb mounted in the handheld lamp, the ultraviolet light bulb capable of emitting light in wavelengths between 3500 and 3800 angstroms;
a pen with a reservoir capable of retaining and dispersing ink in a controlled manner;
ink sensitive to ultraviolet light, the ink fluorescing in the presence of ultraviolet and emitting light in a range between 5000 and 6000 angstroms, said reflected light being in a spectrum visible to human eyes, where the appearance of the ink in light of visible wavelengths being nearly colorless, the ink being stored in the reservoir of the pen; a plurality of sheets of paper; and
a binder with a front cover and a back cover, the front cover and back cover being connected by a binding edge;
retaining means for retaining the plurality of sheets of paper within the binder, the retaining means being attached to the binder at the binding edge, where the plurality of sheets of paper are located within the front cover and the back cover.

6. The journal writing kit of claim 5, further comprising
locking means attached to the front cover and the back cover of the binder, the locking means capable of restricting access to the binder and the paper retained therein.
